(19) United States
(12) Patent Application Publication
(10) Pub. No.: US 2009/0137176 A1
(43) Pub. Date: May 28, 2009

(54) TWO-LAYER FABRIC AND HEAT-RESISTANT PROTECTIVE CLOTHING CONTAINING THE SAME

(75) Inventors: Tomohiro Okuya, Osaka (JP); Hiromi Ozaki, Osaka (JP)

Correspondence Address: SUGHRUE MION, PLLC, 2100 PENNSYLVANIA AVENUE, N.W., SUITE 800, WASHINGTON, DC, 20037, US

(73) Assignee: TEIJIN TECHNO PRODUCTS LIMITED, Osaka (JP)

(21) Appl. No.: 12/063,380

(22) PCT Filed: Jul. 26, 2006
(86) PCT No.: PCT/JP2006/315247

§ 371 Date: Feb. 8, 2008

(30) Foreign Application Priority Data
Aug. 9, 2005 (JP) 2005-230667

(51) Int. Cl. D03D 15/12; B32B 5/26; D03D 13/00

(52) U.S. Cl. 442/189; 442/239; 442/203; 442/255

(57) ABSTRACT

A two-layer fabric according to the present invention has an integral structure containing a base cloth on the upper side and a reinforcing cloth for reinforcing the entire fabric on the under side, wherein (a) the base cloth of the two-layer fabric is flame-retardant and contains a warp yarn and a weft yarn containing 30% by weight or more of a flame-retardant fiber having a limiting oxygen index (LOI) of 26 or more and a tensile strength of 8 cN/dtex or less, (b) the reinforcing cloth of the two-layer fabric contains a warp yarn and a weft yarn containing a heat-resistant high-strength fiber having a tensile strength of 15 cN/dtex or more as a main component, and (c) the base cloth and the reinforcing cloth are connected by the warp yarn and/or the weft yarn of the base cloth, to form the integral structure.

Further, a heat-resistant protective clothing contains an outer fabric layer of the two-layer fabric, stacked and sutured by sewing. The heat-resistant protective clothing has improved properties such as a thermal insulation property and abrasion resistance, in addition to excellent appearance.

### TECHNICAL FIELD

The present invention relates to a two-layer fabric that has a two-layer structure in which a heat-resistant flame-retardant base cloth is reinforced with a reinforcing cloth to be suitably usable as outer fabrics of heat-resistant protective clothings, and relates to a heat-resistant protective clothing containing the two-layer fabric.

More specifically, the invention relates to a novel two-layer fabric suitably usable for human body protective clothings, such as heat-resistant protective clothings for firefighters and the like, protective work clothings against mechanically or chemically hazardous environments, protective clothings against sparks and electric arcs, and protective clothings against explosive environments, and relates to a heat-resistant protective clothing containing the two-layer fabric.

### BACKGROUND ART

A variety of fabrics have been used in the field of human body protective clothings. A wearer can be minimally or sufficiently protected by selecting a fabric having a required property such as strength or heat resistance.

For example, in the case of selecting a flame-retardant fabric for a firefighter uniform, mechanical properties, antistatic properties, waterproof properties, etc. should be taken into consideration in addition to thermal properties (such as resistance to radiogenic or convective heat, thermal stability, and flame retardance). Another fire-resistant fabric for a worker to be exposed to heat is required mainly to be resistant against burn propagation, and further resistant against convective or radiogenic heat. Similarly a protective fabric for welding is required to be nonflammable, resistant against tear propagation, and resistant against small molten metal droplets.

As suggested above, it is very important that the fabrics for the heat-resistant protective clothings have a plurality of properties to maintain safety and comfort of the wearers. In general, the fabrics for the protective clothings are required to have a mechanical property (such as tensile strength or tear strength), heat resistance, flame retardance, chemical stability, an antistatic property, etc.

Ripstop weave has been known as a method for improving tear propagation resistance of fabrics. In the ripstop weave, two warp yarns and two weft yarns are woven in a grid to prevent the tear propagation. By using this weave method, the tear propagation resistance can be increased by about 30%.

However, in this weave method, a lattice pattern and unevenness are disadvantageously formed on the outer side. Thus, fabrics having such structures are more easily abraded and have lower abrasion resistance as compared with plain- or twill-woven, plain and smooth fabrics. Further, the ripstop fabrics are disadvantageous in that the outer sides are always uneven, resulting in poor appearance, as compared with more plain smooth fabrics such as twill-woven fabrics.

Use of a core yarn-type, bicomponent spun yarn has been known as a method for improving mechanical properties of fabrics. In this method, the spun yarn has a center (a core) of a high-strength fiber, which is coated with one or more fibers. The one or more fibers can improve coloring clearness and antistatic properties though they are poor in mechanical properties. The high-strength fiber is poor in resistance to ultraviolet light and abrasion, and thereby is used in the center of the spun yarn to prevent deterioration of physical properties, fibrillation fibrillate, etc.

The core yarn-type spun yarn is disadvantageous in that its width is often limited and a complicated technology is required in its production. For example, in a spun yarn containing an aromatic polyimideamide fiber KERMEL (trade mark) in the sheath, a para-aramid fiber TECHNORA (trade mark) excellent in mechanical properties is used in the core to achieve a sufficient strength. By using the KERMEL (trade mark) in the sheath, the coloring clearness of the product can be improved and the core fiber can be protected.

However, this type of spun yarn is produced by a particular method as described above, so that it is difficult to produce the yarn with a fine count, and the production costs are increased. Further, the core fiber ratio cannot be 35% or more in view of completely coating the core fiber with the sheath fiber, whereby the yarn strength cannot greatly increased. Thus, in the core yarn-type spun yarn, it is remarkably difficult to balance the appearance, physical properties, light weight, and costs.

A process of introducing a yarn of a heat-resistant high-strength fiber regularly into a fabric while maintaining the basic structure of the fabric has been known as another method for improving mechanical properties of fabrics. It is expected that the mechanical properties of the fabric can be improved by the process. In this method, the additionally introduced yarn is composed of an aramid fiber. However, this yarn is inevitably disadvantageous in that it is deteriorated by light during use and is whitened by repeating washing. Thus, the entire fabric has a whitish appearance disadvantageously.

A fabric for a fireman uniform having an integral two-layer structure is proposed in JP-T-2004-530800 (the term “JP-T” as used herein means a published Japanese translation of a PCT patent application). In the fabric, a reinforcing grid is formed on the under side of a base cloth, and the reinforcing grid contains a warp yarn and a weft yarn arranged at a distance of 2 mm. The warp and weft yarns are composed of a material excellent in mechanical properties, different from a fiber for the base cloth. The reinforcing grid is connected to the base cloth by the warp yarn and the weft yarn, to form the integral structure.

However, the disclosed fabric is such that the base cloth and the reinforcing grid are connected by the reinforcing yarns, and a high-strength fiber used for the reinforcing yarns is easily fibrillated by friction, washing, etc. Further, the reinforcing yarns, which connect the base cloth and the reinforcing grid, appear as dots on the upper side of the base cloth. Thus, the reinforcing yarns are deteriorated by light during use and are whitened due to fibrillation by repeating washing, resulting in poor durability. Furthermore, the fabric for strengthening the two-layer fabric is insufficient in reinforcing effect because the reinforcing yarns are arranged in the lattice pattern at the distance of 2 mm.

### DISCLOSURE OF THE INVENTION

An object of the present invention is to solve the above conventional problems, thereby providing a two-layer fabric having improved satisfactory properties suitable for protective clothings such as a thermal insulation property and abrasion resistance, in addition to excellent appearance.

Thus, a two-layer fabric according to the invention comprises an integral structure containing a base cloth on the upper side and a reinforcing cloth for reinforcing the entire fabric on the under side, wherein (a) the base cloth of the two-layer fabric is flame-retardant and comprises a warp yarn and a weft yarn containing 30% by weight or more of a flame-retardant fiber having a limiting oxygen index (LOI) of 26 or more and a tensile strength of 8 cN/dtex or less, (b) the reinforcing cloth of the two-layer fabric comprises a warp yarn and a weft yarn containing a heat-resistant high-strength fiber having a tensile strength of 15 cN/dtex or more as a main component, and (c) the base cloth and the reinforcing cloth are connected by the warp yarn and/or the weft yarn of the base cloth, to form the integral structure. A heat-resistant protective clothing according to the invention comprises an outer fabric layer containing the above two-layer fabric, and the outer fabric layer is stacked and sutured by sewing. The object of the invention has been accomplished by the two-layer fabric and the heat-resistant protective clothing.

### BEST MODE FOR CARRYING OUT THE INVENTION

An embodiment of the present invention will be described in detail below.

### (Two-Layer Fabric of the Invention)

The two-layer fabric of the invention basically has an upper-side base cloth comprising a flame-retardant fiber, and an under-side reinforcing cloth comprising a reinforcing yarn containing a heat-resistant high-strength fiber as a main component. The reinforcing cloth is connected to the base cloth by the warp yarn and the weft yarn of the base cloth, to form an integral structure. The fabric of the invention has the two-layer structure, and thereby has an excellent thermal insulation property due to an air space formed between the base cloth and the reinforcing cloth. This thermal insulation property is particularly important for the fabric used for producing a firefighter protective clothing, required to have the property.

The base cloth, which is formed on the upper side of the two-layer fabric of the invention, comprises a flame-retardant fiber having a limiting oxygen index (LOI) of 26 or more and a fiber strength of 8 cN/dtex or less singly, or a mixture of the flame-retardant fiber and a heat-resistant high-strength fiber.

Examples of the flame-retardant fiber having a limiting oxygen index (LOI) of 26 or more and a fiber strength of 8 cN/dtex or less include meta-aramid fibers, polyimide fibers, polyamideimide fibers, polyetherimide fibers, polybenzimidazole fibers, novoloid fibers, polychlal fibers, flame-retardant acrylic fibers, flame-retardant rayon fibers, flame-retardant polyester fibers, flame-retardant cotton fibers, and flame-retardant wool fibers. Among the flame-retardant fibers, preferred are meta-aramid fibers having excellent LOI values, such as fibers of poly(m-phenylene isophthalamide) or copolymers containing 90% by mole or more of m-phenylene isophthalamide unit.

In a preferred embodiment, the heat-resistant high-strength fiber is mixed with the flame-retardant fiber. Examples of the heat-resistant high-strength fibers include para-aramid fibers (and para-aramid copolymer fibers), polyallylate fibers, poly(p-phenylene benzobisoxazole) fibers, and carbon fibers. It is particularly preferred that the flame-retardant fiber is mixed with the heat-resistant high-strength fiber of the para-aramid fiber (i.e. poly(p-phenylene terephthalamide) fiber) or a para-aramid copolymer fiber containing a third component to increase the fabric strength. Examples of the latter poly(p-phenylene terephthalamide) copolymer fibers include a fiber of copoly(p-phenylene-3,4′-oxydiphenylene terephthalamide) known under the trade name of TECHNORA (trade mark).

In the case of mixing the flame-retardant fiber and the heat-resistant high-strength fiber, the ratio of the flame-retardant fiber in the mixture is required to be 30% by weight or more at least, and is preferably 50% by weight or more. Thus, in this case, the ratio of the heat-resistant high-strength fiber in the mixture is preferably at least 5% by weight and less than 70% by weight. When the mixing ratio of the heat-resistant high-strength fiber is less than 5% by weight, the fabric is shrunk by flame in some cases. Further, in general, this type of fiber is easily fibrillated and is less light-resistant. Thus, when the ratio of the fiber is more than 70% by weight, the fiber is often fibrillated and deteriorated by light, and such ratio is not preferred from the viewpoint of appearance.

The flame-retardant fiber and the heat-resistant high-strength fiber may be used in the state of continuous fiber or short fiber spun. In the case of mixing the fibers, a short fiber spun yarn (a blended yarn) is preferably used in view of texture and mixing easiness, though continuous fibers may be commingled or twisted. The spun yarn may be obtained by mixing and spinning fibers different in type, fineness, fiber length, etc.

The fabric constituting the base cloth is a plain-, twill-, or satin-woven cloth obtained by using the warp yarn and the weft yarn containing 30% by weight or more of the flame-retardant fiber.

On the other hand, the reinforcing cloth, which is formed on the under side of the two-layer fabric of the invention, contains a heat-resistant high-strength fiber having a fiber strength of 15 cN/dtex or more as a main component. The term “heat-resistant” used herein means that the fiber has a heat decomposition temperature of 330° C. or higher.

It is more preferred that the heat-resistant high-strength fiber is a para-aramid fiber (i.e. poly(p-phenylene terephthalamide) fiber) or a para-aramid copolymer fiber containing a third component, which has a high reinforcing effect. Examples of the former poly(p-phenylene terephthalamide) fibers include a commercially available fiber with the trade name of TWARON (trade mark). Examples of the latter p-phenylene terephthalamide copolymer fibers include a copoly(p-phenylene-3,4′-oxydiphenylene terephthalamide) fiber. Such a preferred para-aramid copolymer fiber with the trade name of TECHNORA (trade mark) is commercially available. The heat-resistant high-strength fiber may be mixed with a small amount (e.g. less than 30% by weight) of the above described flame-retardant fiber. For example, at least one of the warp yarn and the weft yarn of the reinforcing cloth may be a blended yarn containing the heat-resistant high-strength fiber and the flame-retardant fiber, the ratio of the former fiber being more than 70% by weight.

The heat-resistant high-strength fiber for the reinforcing cloth may be used in the state of continuous fiber or short fiber, and the state may be selected in accordance with the intended use. For example, the continuous fiber is preferred to improve the reinforcing effect, and the short fiber can be easily mixed or blended with another fiber and thereby is preferred to improve another property (e.g. higher flame retardance) in addition to the reinforcing effect. Also in the case of mixing the heat-resistant high-strength fiber with another fiber, the main component of the reinforcing cloth should be the heat-resistant high-strength fiber, and the ratio of the heat-resistant high-strength fiber is preferably 70% by weight or more.

The warp yarn and the weft yarn of the reinforcing cloth (which may be referred to as reinforcing yarns in the invention) preferably contain a fiber having mechanical properties, more excellent than those of the flame-retardant fiber for the base cloth. As a result, the tear strength, tear propagation, and dimensional stability of the fabric are greatly improved, the decomposition opening resistance (the resistance against hole formation on the fabric due to decomposition by flame exposure for a long period) is increased, and the resistance against electric arc flash is increased. Thus, the two-layer fabric having the structure can show largely higher resistances as compared with conventional fabrics, even when the fabrics have the same weight.

The size of each of the reinforcing yarns is preferably 400 dtex or less, particularly 50 to 330 dtex. When the size is more than 400 dtex, the weight of the entire two-layer fabric is increased, and it is difficult to produce a protective clothing having a light weight and an excellent thermal insulation property. The reinforcing cloth may be a plain-, twill-, or satin-woven cloth.

The reinforcing cloth is connected to the base cloth in the production of the two-layer fabric of the invention. It is important that the cloths are connected by the warp yarn and/or the weft yarn of the base cloth.

In the two-layer fabric of the invention, the reinforcing cloth is formed from the warp and weft reinforcing yarns, which are preferably plain-, twill-, or satin-woven. The base cloth and the reinforcing cloth are connected by the yarn used in the base cloth, so that the entire base cloth is composed of the same material. As a result, the entire upper side (i.e. the outer side) of the two-layer fabric is composed of the same material, the under-side reinforcing cloth composed of the strong fabric containing the reinforcing yarns, and the reinforcing cloth is completely invisible externally.

As compared with conventional ripstop fabrics, the two-layer fabric of the invention having the above structure has a higher abrasion resistance of the outer surface, more excellent smoothness, higher friction resistance, and more excellent appearance. Further, the fabric has a smooth outer surface, whereby a print can be formed on the surface.

In the two-layer fabric of the invention, it is preferred that the number ratio between the yarns of the base cloth (the base cloth yarns) and the reinforcing yarns is within a range of [the base cloth yarns/the reinforcing yarns=4/1 to 1/1], from the viewpoints of the reinforcing effect and hiding property. When the ratio of the reinforcing yarns is too small, the reinforcing effect is lowered. When the ratio of the reinforcing yarns is more than that of the base cloth yarns, the reinforcing cloth is not completely covered with the base cloth yarns, so that the reinforcing yarns are fibrillated by abrasion or deteriorated in strength by ultraviolet light, resulting in many problems, though the reinforcing effect is large.

In the invention, the fabric has the two-layer structure, so that an air space is formed between the base cloth and the reinforcing cloth, and the fabric has an increased thickness and thereby has an improved thermal insulation property. When the shrinkage difference between the base cloth and the reinforcing cloth is large, a convexoconcave structure is formed at the under side of the fabric by flame exposure. The thermal insulation property of the fabric is further improved by the formation of the convexoconcave structure. Further, even a material that is less resistant to ultraviolet light irradiation, friction, etc. can be used in the reinforcing yarns in the two-layer structure, whereby the fabric can have both the strength and excellent appearance.

For example, an electrically conductive yarn may be used in the base cloth and/or the reinforcing cloth to obtain a fabric having an additional property such as an antistatic property or electric conductivity. More specifically, for example, the fabric having the antistatic property or electric conductivity can be obtained such that an electrically conductive carbon is kneaded into a para-aramid, thus prepared electrically conductive filament is twisted with the base cloth yarn or the reinforcing yarn, the obtained twisted yarn containing about 1% to 3% of the electrically conductive fiber is woven in the warp direction at an appropriate distance. In this case, when the electrically conductive yarn is used in the under-side reinforcing cloth, the resultant fabric can show desired electric properties while maintaining the excellent appearance on the upper side.

A yarn blended with a carbon fiber filament, etc. may be used in the reinforcing cloth to increase the friction resistance, if necessary. Further, another material such as a microencapsulated material, a shape variation material, or a grafted yarn may be introduced thereto.

### (Heat-Resistant Protective Clothing of the Invention)

The heat-resistant protective clothing of the invention having a heat resistance, light weight, and thermal insulation property can be produced by using the above described two-layer fabric of the invention.

The heat-resistant protective clothing has the two-layer fabric of the invention in an outer fabric layer, and preferably comprises a multilayer stack structure containing the outer fabric layer. For example, (a) the outer fabric layer containing the two-layer fabric of the invention, (b) an intermediate layer having a moisture-permeable waterproof property, and (c) a backing fabric layer of a thermal insulation layer are preferably stacked in this order in the multilayer structure.

In the multilayer structure, the intermediate layer preferably has the moisture-permeable waterproof property, and is most preferably such that a moisture-permeable waterproof thin film is stacked on a fabric of a meta- or para-aramid fiber. Particularly, in an optimum example, the intermediate layer is a laminate of a woven fabric containing a flame-retardant meta-aramid fiber such as a poly (m-phenylene isophthalamide) fiber and a moisture-permeable waterproof thin film containing polytetrafluoroethylene, etc. By introducing the intermediate layer, the moisture-permeable waterproof property and chemical resistance of the fabric are improved, and evaporation of wearer's sweat is accelerated to reduce the heat stress to the wearer.

A fabric textile having a high air content can be effectively used in the backing thermal insulation layer. In this case, the thermal insulation layer contains a large amount of air having low thermal conductivity. The thermal insulation layer may have a single layer structure or a multilayer structure of 2 to 4 layers. The thermal insulation layer preferably contains a fabric or felt of a flame-retardant fiber such as a meta-aramid fiber. The fabric for the heat-resistant protective clothing of the invention may have such a multilayer structure containing the outer fabric layer, the intermediate layer, and the thermal insulation layer. The layers do not have to be connected to each other previously, and may be stacked and sutured in a sewing step.

### EXAMPLE

The constitutions and effects of the present invention will be described in more detail below with reference to Examples. It should be noted that physical properties are obtained in Examples as follows.

### (1) Limiting Oxygen Index (LOI)

Obtained by a method according to JIS K 7201.

### (2) Fiber Strength

Obtained by a method according to JIS L 1013.

### (3) Fabric Weight

Obtained by a method according to JIS L 1096.

### (4) Fabric Thickness

Obtained by a method according to JIS L 1096.

### (5) Tensile Strength

Obtained by a method according to JIS L 1096, method A (labeled strip method).

### (6) Tear Strength

Obtained by a method according to JIS L 1096, method A-1 (single tongue method).

### (7) Light Fastness

Obtained by a method according to JIS L 0842, third exposure method (light resistance test).

### (8) Abrasion Strength

Obtained by a method according to JIS L 1096, method A-1 (universal method).

### (9) Appearance

The outer appearance of the outer fabric layer is visually observed and evaluated (the presence of convexoconcave or color unevenness debases the evaluation result) using 4 ranks of Excellent, Good, Insufficient, and Bad.

### (10) Washing Resistance

The outer appearance of the fabric is visually observed and evaluated using 4 ranks of Excellent, Good, Insufficient, and Bad after the fabric is washed ten times according to JIS L 0217, method 103.

### (11) Thermal Insulation Property

Obtained by methods according to ISO 9151:1995 (convective heat), ISO 6942:1993 (radiant heat), and ISO 17492:2003 (combination of convective heat and radiant heat).

The following measured values were used for the thermal insulation property.

### ISO 9151:1995

HTI₂₄: Heat Transfer Index

### ISO 6942:1993

t₂: time necessary to reach the level 2

### ISO 17492:2003

TPP Time: Heat-transfer burn time (second)

The thermal insulation property is comprehensively evaluated from the measured values using 4 ranks of Excellent, Good, Insufficient, and Bad.

### (12) State of Under Side of Fabric After ISO 9151 Measurement

After flame exposure of ISO 9151, the under side of the fabric is visually observed and evaluated based on the presence of convexoconcave.

### Example 1

### Production of Two-Layer Fabric

A poly(m-phenylene isophthalamide) fiber CONEX (trade mark, available from Teijin Techno Products Limited, LOI=32, fiber strength=4.0 cN/dtex) and a copoly(p-phenylene-3,4′-oxydiphenylene terephthalamide) fiber TECHNORA (trade mark, available from Teijin Techno Products Limited, LOI=25, fiber strength=22.0 cN/dtex) were blended at a blending ratio (weight ratio) of 95:5 to prepare warp and weft spun yarns (count: 40/2=292 dtex), and the yarns were 2/1-twill-woven to form a base cloth for the upper side of a two-layer fabric.

A warp spun yarn (count 40/2=292 dtex) and a weft spun yarn (count 40/1=146 dtex), which were both composed of a copoly(p-phenylene-3,4′-oxydiphenylene terephthalamide) fiber TECHNORA (trade mark, available from Teijin Techno Products Limited, LOI=25, fiber strength=22.0 cN/dtex), were plain-woven to form a reinforcing cloth on the under side of the upper base cloth.

In the process, the number ratios between the base cloth yarn for the base cloth and the reinforcing yarn for the reinforcing cloth (the base cloth yarn/the reinforcing yarn) were 3/2 with respect to the warp yarns and 1/1 with respect to the weft yarns. Thus, a two-layer fabric (weight: 265 g/m²) was produced such that the reinforcing cloth was connected to the base cloth by the base cloth yarn to form the two-layer structure in the weave process.

### (Production and Evaluation of Fabric for Protective Clothing)

The obtained two-layer fabric (a heat-resistant fabric) was used as an outer fabric layer, a laminate (weight: 105 g/m²) of a woven cloth composed of a spun yarn (count 40/1=146 dtex) of a poly(m-phenylene isophthalamide) fiber CONEX (trade mark) and a polytetrafluoroethylene film having a moisture-permeable waterproof property (available from Japan Gore-Tex, Inc.) was placed as an intermediate layer on the under side of the reinforcing cloth of the fabric, and a fabric (weight 150 g/m²) prepared by honey-comb-weaving a spun yarn (count 40/1=146 dtex) composed of a poly(m-phenylene isophthalamide) fiber was placed as a thermal insulation layer (a backing) on the under side of the laminate.

The outer fabric layer, the intermediate layer, and the thermal insulation layer were stacked and sewed, to produce a fabric for a heat-resistant protective clothing. The results of evaluating the obtained fabric for a heat-resistant protective clothing are shown in Table 1.

### Example 2

A two-layer fabric was produced in the same manner as Example 1 except that the same poly(m-phenylene isophthalamide) fiber CONEX (trade mark) and the same copoly(p-phenylene-3,4′-oxydiphenylene terephthalamide) fiber TECHNORA (trade mark) were blended at a blending ratio (weight ratio) of 60:40 to prepare heat-resistant base cloth yarns (count 40/2=292 dtex).

A fabric for a heat-resistant protective clothing was produced in the same manner as Example 1 using the intermediate layer and the backing cloth of Example 1, except that the above obtained two-layer fabric (a heat-resistant fabric) was used as the outer fabric layer. The results of evaluating the obtained fabric for a heat-resistant protective clothing are shown in Table 1.

### Example 3

A two-layer fabric was produced in the same manner as Example 1 except that the same poly(m-phenylene isophthalamide) fiber CONEX (trade mark) and the same copoly(p-phenylene-3,4′-oxydiphenylene terephthalamide) fiber TECHNORA (trade mark) were blended at a blending ratio (weight ratio) of 40:60 to prepare base cloth yarns (count 40/2=292 dtex).

A fabric for a heat-resistant protective clothing was produced in the same manner as Example 1 using the intermediate layer and the thermal insulation layer (the backing cloth) of Example 1, except that the above obtained two-layer fabric (a heat-resistant fabric) was used as the outer fabric layer. The results of evaluating the obtained fabric for a heat-resistant protective clothing are shown in Table 1.

### Comparative Example 1

A two-layer fabric was produced in the same manner as Example 1 except that a poly (m-phenylene isophthalamide) fiber (LOI=32, fiber strength=4.0 cN/dtex) and a copoly(p-phenylene-3,4′-oxydiphenylene terephthalamide) fiber (LOI=25, fiber strength=22.0 cN/dtex) were blended at a blending ratio (weight ratio) of 10:90 to prepare base cloth yarns (count 40/2=292 dtex).

A fabric for a heat-resistant protective clothing was produced in the same manner as Example 1 using the intermediate layer and the backing cloth of Example 1, except that the above obtained two-layer fabric was used as the outer fabric layer. The results of evaluating the obtained fabric for a heat-resistant protective clothing are shown in Table 2.

### Comparative Example 2

A two-layer fabric was produced as an outer fabric layer for a heat-resistant protective clothing in the following manner. A poly(m-phenylene isophthalamide) fiber (LOI=32, fiber strength=4.0 cN/dtex) and a copoly(p-phenylene-3,4′-oxydiphenylene terephthalamide) fiber (LOI=25, fiber strength=22.0 cN/dtex) were blended at a blending ratio (weight ratio) of 90:10 to prepare base spun yarns (count: 40/2=292 dtex), and the yarns were 2/1-twill-woven to form an upper-side cloth for the two-layer fabric. A spun yarn (count: 40/2=292 dtex) composed of a copoly(p-phenylene-3,4′-oxydiphenylene terephthalamide) fiber was woven in a grid pattern to form a reinforcing cloth on the under side of the upper base cloth. The grid-patterned reinforcing cloth was connected to the upper cloth by a reinforcing yarn.

The number ratios between the upper cloth yarn (the base cloth yarn) and the reinforcing yarn (the base cloth yarn/the reinforcing yarn) were 6/1 with respect to the warp yarns and 5/1 with respect to the weft yarns. The reinforcing cloth had a 2-mm grid pattern. A two-layer fabric (weight: 230 g/m²) was produced in this manner.

A fabric for a heat-resistant protective clothing was produced in the same manner as Example 1 using the intermediate layer and the backing cloth of Example 1, except that the above obtained two-layer fabric was used as the outer fabric layer. The results of evaluating the obtained fabric for a heat-resistant protective clothing are shown in Table 2.

### Comparative Example 3

A poly(m-phenylene isophthalamide) fiber (LOI=32, fiber strength=4.0 cN/dtex) and a copoly(p-phenylene-3,4′-oxydiphenylene terephthalamide) fiber (LOI=25, fiber strength=22.0 cN/dtex) were blended at a blending ratio (weight ratio) of 90:10 to prepare a heat-resistant spun yarn (count 20/2=584 tex), and the yarn was 2/1-twill-woven to obtain a fabric (weight: 280 g/m²).

A fabric for a heat-resistant protective clothing was produced in the same manner as Example 1 using the intermediate layer and the backing cloth of Example 1, except that the above obtained fabric was used as the outer fabric layer. The results of evaluating the obtained fabric for a heat-resistant protective clothing are shown in Table 2.

### Comparative Example 4

A poly(m-phenylene isophthalamide) fiber (LOI=32, fiber strength=4.0 cN/dtex) and a copoly(p-phenylene-3,4′-oxydiphenylene terephthalamide) fiber (LOI=25, fiber strength=22.0 cN/dtex) were blended at a blending ratio (weight ratio) of 90:10 to prepare heat-resistant warp and weft yarns (count 20/2=584 tex), and two warp yarns and two weft yarns were plain-woven at a distance of 6 mm, to obtain a fabric having a plain-woven rip structure (weight: 245 g/m²) which was used as the outer fabric layer.

A fabric for a heat-resistant protective clothing was produced in the same manner as Example 1 using the intermediate layer and the backing cloth of Example 1, except that the above obtained heat-resistant fabric was used as the outer fabric layer. The results of evaluating the obtained fabric for a heat-resistant protective clothing are shown in Table 2.

TABLE 1

| Item | Unit | Example 1 | Example 2 | Example 3 |
|---|---|---|---|---|
| Meta-aramid content of | % | 95 | 60 | 40 |
| outer base cloth | | | | |
| Outer fabric layer | — | Two-layer | Two-layer | Two-layer |
| structure | | structure | structure | structure |
| Material of reinforcing | — | Para-aramid | Para-aramid | Para-aramid |
| cloth in outer fabric layer | | | | |
| Outer fabric layer | mm | 0.62 | 0.62 | 0.62 |
| thickness | | | | |
| Outer fabric layer weight | g/m² | 265 | 265 | 265 |
| Intermediate layer weight | g/m² | 105 | 105 | 105 |
| Backing cloth weight | g/m² | 150 | 150 | 150 |
| Total weight | g/m² | 520 | 520 | 520 |
| Tensile strength (warp) | N/5 cm | 2500 | 3200 | 3500 |
| Tear strength (warp) | N | 180 | 200 | 250 |
| Abrasion strength | number | 900 | 1300 | 1600 |
| Light fastness | class | 4 | 3.5 | 3 |
| Upper side appearance | rank | Good | Good | Good |
| Washing resistance | rank | Excellent | Good | Good |
| ISO 9151 (convective heat) | second | 20 | 18.5 | 17.5 |
| | (HTI₂₄) | | | |
| ISO 6942 (radiant heat) | second | 27 | 26 | 25 |
| | (t₂) | | | |
| ISO 17492 (combination of | Second | 19.0 | 17.5 | 16.5 |
| convective heat and | TPP Time | | | |
| radiant heat) | | | | |
| Comprehensive evaluation | rank | Excellent | Excellent | Good |
| of thermal insulation | | | | |
| property | | | | |
| Under side cloth state | rank | Convexoconcave | Convexoconcave | Convexoconcave |
| after ISO 9151 measurement | | was formed | was formed | was not formed |

The upper side appearance and washing resistance were evaluated using ranks of Excellent, Good, Insufficient, and Bad.
The thermal insulation property was comprehensively evaluated based on the total of HTI₂₄, t₂, and TPP Time using ranks of Excellent (60 or more), Good (55 or more and less than 60), Insufficient (50 or more and less than 55), and Bad (less than 50).
The under side cloth state after ISO 9151 measurement was evaluated based on the presence of convexoconcave.

TABLE 2

| | | Comparative | Comparative | Comparative | Comparative |
|---|---|---|---|---|---|
| Item | Unit | Example 1 | Example 2 | Example 3 | Example 4 |
| Meta-aramid content | % | 10 | 90 | 90 | 90 |
| of outer base cloth | | | | | |
| Outer fabric layer | — | Two-layer | Two-layer | Twill weave | Plain ripstop |
| structure | | structure | structure | | |
| Material of | — | Para-aramid | Para-aramid | — | — |
| reinforcing cloth in | | | | | |
| outer fabric layer | | | | | |
| Outer fabric layer | mm | 0.62 | 0.60 | 0.65 | 0.50 |
| thickness | | | | | |
| Outer fabric layer | g/m² | 265 | 230 | 280 | 245 |
| weight | | | | | |
| Intermediate layer | g/m² | 105 | 105 | 105 | 105 |
| weight | | | | | |
| Backing cloth weight | g/m² | 150 | 150 | 150 | 150 |
| Total weight | g/m² | 520 | 485 | 535 | 500 |
| Tensile strength | N/5 cm | 4000 | 1500 | 2000 | 1500 |
| (warp) | | | | | |
| Tear strength (warp) | N | 300 | 150 | 100 | 150 |
| Abrasion strength | number | 1800 | 500 | 350 | 250 |
| Light fastness | class | 1 | 4 | 4 | 4 |
| Upper side | rank | Good | Bad | Good | Insufficient |
| appearance | | | | | |
| Washing resistance | rank | Bad | Bad | Excellent | Excellent |
| ISO 9151 (convective | second | 16.5 | 16 | 15 | 14 |
| heat) | (HTI₂₄) | | | | |
| ISO 6942 (radiant | second | 25 | 24 | 23 | 22 |
| heat) | (t₂) | | | | |
| ISO 17492 | Second | 15.5 | 14.5 | 14.5 | 13.5 |
| (combination of | TPP Time | | | | |
| convective heat and | | | | | |
| radiant heat) | | | | | |
| Comprehensive | rank | Good | Insufficient | Insufficient | Bad |
| evaluation of | | | | | |
| thermal insulation | | | | | |
| property | | | | | |
| Under side cloth | rank | Convexoconcave | Convexoconcave | Convexoconcave | Convexoconcave |
| state after ISO 9151 | | was not formed | was not formed | was not formed | was not formed |
| measurement | | | | | |

The upper side appearance and washing resistance were evaluated using ranks of Excellent, Good, Insufficient, and Bad.
The thermal insulation property was comprehensively evaluated based on the total of HTI₂₄, t₂, and TPP Time using ranks of Excellent (60 or more), Good (55 or more and less than 60), Insufficient (50 or more and less than 55), and Bad (less than 50).
The under side cloth state after ISO 9151 measurement was evaluated based on the presence of convexoconcave.

### INDUSTRIAL APPLICABILITY

According to the present invention, there is provided the two-layer fabric, which shows satisfactory properties suitable for protective clothings and improved characteristics of thermal insulation property, abrasion resistance, etc. while maintaining an excellent upper appearance. The heat-resistant protective clothing obtained by stacking and suturing the outer fabric layer of the two-layer fabric shows improved characteristics of thermal insulation property, abrasion resistance, etc. while maintaining an excellent upper appearance. Thus, the heat-resistant protective clothing can be suitably used as heat-resistant protective clothings for firefighters, protective work clothings against mechanically or chemically hazardous environments, protective clothings against sparks and electric arcs, protective clothings against explosive environments, etc.

1. A two-layer fabric comprising an integral structure having a base cloth on the upper side and a reinforcing cloth for reinforcing the entire fabric on the under side, wherein
(a) the base cloth of the two-layer fabric is flame-retardant and comprises a warp yarn and a weft yarn containing 30% by weight or more of a flame-retardant fiber having a limiting oxygen index (LOI) of 26 or more and a tensile strength of 8 cN/dtex or less,
(b) the reinforcing cloth of the two-layer fabric comprises a warp yarn and a weft yarn containing a heat-resistant high-strength fiber having a tensile strength of 15 cN/dtex or more as a main component, and
(c) the base cloth and the reinforcing cloth are connected by the warp yarn and/or the weft yarn of the base cloth, to form the integral structure.

2. A two-layer fabric according to claim 1, wherein the warp yarn and the weft yarn of the reinforcing cloth each have a size of 400 dtex or less, and the number ratios of the warp yarns and the weft yarns between the base cloth and the reinforcing cloth are within a range of [the base cloth/the reinforcing cloth=4/1 to 1/1].

3. A two-layer fabric according to claim 1, wherein the flame-retardant fiber of the base cloth comprises at least one fiber selected from the group consisting of meta-aramid fibers, polyimide fibers, polyamideimide fibers, polyetherimide fibers, polybenzimidazole fibers, novoloid fibers, polychlal fibers, flame-retardant acrylic fibers, flame-retardant rayon fibers, flame-retardant polyester fibers, flame-retardant cotton fibers, and flame-retardant wool fibers.

4. A two-layer fabric according to claim 1, wherein the warp yarn and/or the weft yarn of the base cloth contain at least one fiber selected from the group consisting of para-aramid fibers, polyallylate fibers, poly(p-phenylene benzoxazole) fibers, and carbon fibers, in addition to the flame-retardant fiber.

5. A two-layer fabric according to claim 1, wherein the heat-resistant high-strength fiber of the reinforcing cloth comprises at least one fiber selected from the group consisting of para-aramid fibers, polyallylate fibers, poly(p-phenylene benzoxazole) fibers, and carbon fibers.

6. A two-layer fabric according to claim 1, wherein the flame-retardant base cloth is a plain-, twill-, or satin-woven cloth.

7. A two-layer fabric according to claim 1, wherein the reinforcing cloth is a reinforcing fabric of a plain-, twill-, or satin-woven cloth.

8. A heat-resistant protective clothing, comprising an outer fabric layer containing a two-layer fabric according to claim 1, wherein the outer fabric layer is stacked and sutured by sewing.

9. A heat-resistant protective clothing according to claim 8, wherein, an intermediate layer containing a moisture-permeable waterproof film and a flame-retardant fiber, and at least one thermal insulation layer are stacked and sutured by sewing to the outer fabric layer containing the two-layer fabric.

10. A heat-resistant protective clothing according to claim 9, wherein the thermal insulation layer contains a fabric or felt of a flame-retardant fiber.

11. A two-layer fabric according to claim 2, wherein the flame-retardant fiber of the base cloth comprises at least one fiber selected from the group consisting of meta-aramid fibers, polyimide fibers, polyamideimide fibers, polyetherimide fibers, polybenzimidazole fibers, novoloid fibers, polychlal fibers, flame-retardant acrylic fibers, flame-retardant rayon fibers, flame-retardant polyester fibers, flame-retardant cotton fibers, and flame-retardant wool fibers.

12. A two-layer fabric according to claim 2, wherein the warp yarn and/or the weft yarn of the base cloth contain at least one fiber selected from the group consisting of para-aramid fibers, polyallylate fibers, poly(p-phenylene benzoxazole) fibers, and carbon fibers, in addition to the flame-retardant fiber.

13. A two-layer fabric according to claim 3, wherein the warp yarn and/or the weft yarn of the base cloth contain at least one fiber selected from the group consisting of para-aramid fibers, polyallylate fibers, poly(p-phenylene benzoxazole) fibers, and carbon fibers, in addition to the flame-retardant fiber.

14. A two-layer fabric according to claim 2, wherein the heat-resistant high-strength fiber of the reinforcing cloth comprises at least one fiber selected from the group consisting of para-aramid fibers, polyallylate fibers, poly(p-phenylene benzoxazole) fibers, and carbon fibers.

15. A two-layer fabric according to claim 3, wherein the heat-resistant high-strength fiber of the reinforcing cloth comprises at least one fiber selected from the group consisting of para-aramid fibers, polyallylate fibers, poly(p-phenylene benzoxazole) fibers, and carbon fibers.

16. A two-layer fabric according to claim 4, wherein the heat-resistant high-strength fiber of the reinforcing cloth comprises at least one fiber selected from the group consisting of para-aramid fibers, polyallylate fibers, poly(p-phenylene benzoxazole) fibers, and carbon fibers.

17. A two-layer fabric according to claim 2, wherein the flame-retardant base cloth is a plain-, twill-, or satin-woven cloth.

18. A two-layer fabric according to claim 3, wherein the flame-retardant base cloth is a plain-, twill-, or satin-woven cloth.

19. A two-layer fabric according to claim 4, wherein the flame-retardant base cloth is a plain-, twill-, or satin-woven cloth.

20. A two-layer fabric according to claim 5, wherein the flame-retardant base cloth is a plain-, twill-, or satin-woven cloth.
